(19) United States
(12) Patent Application Publication
(10) Pub. No.: US 2020/0180650 A1
(43) Pub. Date: Jun. 11, 2020

(54) APPARATUS FOR AUTONOMOUS DRIVING CONTROL AND RELIABILITY INFORMATION GUIDANCE METHOD THEREOF

(71) Applicants: Hyundai Motor Company, Seoul (KR); Kia Motors Corporation, Seoul (KR)

(72) Inventors: Jin Hyung Lee, Seoul (KR); Jeong Woo Lee, Suwon-si (KR); Deok Hwan Seo, Incheon (KR); Jong Chan Jun, Hwaseongsi-Gyeonggi-do (KR); Kwon Hyoung Choi, Suwon-si (KR)

(73) Assignees: Hyundai Motor Company, Seoul (KR); Kia Motors Corporation, Seoul (KR)

(21) Appl. No.: 16/540,756

(22) Filed: Aug. 14, 2019

(30) Foreign Application Priority Data
Dec. 10, 2018 (KR) 10-2018-0158619

(51) Int. Cl. B60W 50/02; B60W 50/04; B60W 50/16; B60W 40/12; G05D 1/00

(52) U.S. Cl. CPC B60W 50/0205; B60W 50/045; B60W 50/16; B60W 40/12; B60W 2050/0215; G05D 1/0055; G05D 2201/0213; B60W 2520/26; B60W 2510/18; G05D 1/0088

(57) ABSTRACT

An autonomous driving control apparatus includes an information collection device collecting driving information of an autonomous driving vehicle, an calculation device computing reliability according to autonomous driving control based on the collected driving information, and a controller controlling driving of the autonomous driving vehicle and displaying reliability information according to the autonomous driving control on a display.

### CROSS-REFERENCE TO RELATED APPLICATION

The present application claims priority to and the benefit of Korean Patent Application No. 10-2018-0158619, filed on Dec. 10, 2018, which is incorporated herein by reference in its entirety.

### TECHNICAL FIELD

The present disclosure relates to an autonomous driving control apparatus and reliability information guidance method thereof.

### BACKGROUND

The statements in this section merely provide background information related to the present disclosure and may not constitute prior art.

The autonomous driving system of a vehicle is a technology that automatically controls the driving depending on a preset driving setting value, without a driver's manipulation.

Because the driver does not intervene in the autonomous driving system, methods for safe driving are being developed. The autonomous driving system may allow the driver to switch to manual mode when autonomous driving fails or when the driver requests the control of the vehicle.

However, because the conventional autonomous driving system does not notify the driver whether the current control state of the vehicle is stable, the driver may not still relieve anxiety.

### SUMMARY

An aspect of the present disclosure provides an autonomous driving control apparatus that allows a driver to feel secure during autonomous driving by computing the reliability of each of a plurality of items to notify the driver of reliability information while the autonomous driving of a vehicle is performed, and a reliability information guidance method thereof.

Another aspect of the present disclosure provides an autonomous driving control apparatus that improves safety by allowing a user to recognize a reliability warning state through an alarm when reliability information computed during the autonomous driving is less than a user setting value, and a reliability information guidance method thereof.

The technical problems to be solved by the present disclosure are not limited to the aforementioned problems, and any other technical problems not mentioned herein will be clearly understood from the following description by those skilled in the art to which the present disclosure pertains.

In one aspect of the present disclosure, an autonomous driving control apparatus includes an information collection device collecting driving information of an autonomous driving vehicle, an calculation device computing reliability according to autonomous driving control based on the collected driving information, and a controller controlling driving of the autonomous driving vehicle and displaying reliability information according to the autonomous driving control on a display.

The driving information includes at least one or more of operating state information of the autonomous driving vehicle, external environment information of the autonomous driving vehicle, road information of the autonomous driving vehicle on a driving route, and state information of a sensor that senses respective information.

The calculation device computes each of first reliability based on safety of vehicle control, second reliability based on accuracy of external environment information, and third reliability based on complexity of a driving route.

The calculation device computes the first reliability based on operating state information and external environment information of the autonomous driving vehicle.

The calculation device computes a first deduction rate based on at least one or more of weather information, an actual braking amount based on an estimated braking amount, an amount of wheel slip during acceleration, an actual movement route based on a target movement route, or the number of times that an attitude control system is operated and adjusts the first reliability to be low based on the computed first deduction rate.

The calculation device computes the second reliability based on the external environment information of the autonomous driving vehicle and state information of a sensor.

The calculation device computes a second deduction rate based on at least one or more of information about image recognition error or failure of a camera, a difference in brightness between a lane area and a road area in an image, a camera exposure value, the number of times that object tracking fails, and GPS signal strength and adjusts the second reliability to be low based on the computed second deduction rate.

The calculation device computes the third reliability based on operating state information of the autonomous driving vehicle and road information on the driving route.

The calculation device computes a third deduction rate based on at least one or more of curvature and a length of a curve section, the number of lane changes, the number of nodes, a distance of a congested section, and the number of times that a change of the driving route is detected, which is within a specific distance from a current location on the driving route and adjusts the third reliability to be low based on the computed third deduction rate.

The calculation device computes final reliability according to the autonomous driving control by combining the first reliability, the second reliability, and the third reliability.

The controller outputs an alarm control signal, when the reliability according to the autonomous driving control is less than a preset setting value.

The autonomous driving control apparatus further includes an alarm device including an alarm means that outputs an alarm depending on the alarm control signal.

The alarm means includes at least one or more of a vibration means of a steering wheel and a seat vibration means.

The controller outputs a message for guiding a state of the reliability and inducing adjustment of a driving setting value, when the reliability according to the autonomous driving control is less than a preset setting value.

The controller automatically adjusts a driving setting value, when a state where the reliability according to the autonomous driving control is less than a preset setting value is maintained during a specified time or more.

The controller searches for a safety zone located at a closest distance to control the vehicle to stop in the safety zone, when the reliability is not restored to a preset setting value or more or the driving setting value is not adjusted by a driver, after performing the autonomous driving control depending on the automatically adjusted driving setting value.

In another aspect of the present disclosure, a reliability information guidance method of an autonomous driving control apparatus includes collecting driving information of an autonomous driving vehicle, computing reliability according to autonomous driving control based on the collected driving information, and controlling driving of the autonomous driving vehicle and to display reliability information according to the autonomous driving control on a display.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of an autonomous driving control apparatus, in one form of the present disclosure;

FIGS. 2 to 6B are views illustrating an form for describing an operation of an autonomous driving control apparatus, in one form of the present disclosure;

FIG. 7 is a diagram illustrating an operation flow of a reliability information guidance method of an autonomous driving control apparatus, in one form of the present disclosure;

FIG. 8 is a diagram illustrating an operation flow of a reliability information guidance method of an autonomous driving control apparatus, in one form of the present disclosure; and

FIG. 9 is a diagram illustrating a computing system performing a method, in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In describing the components of some forms of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure relates to an autonomous driving control apparatus and may be applied to an autonomous driving vehicle.

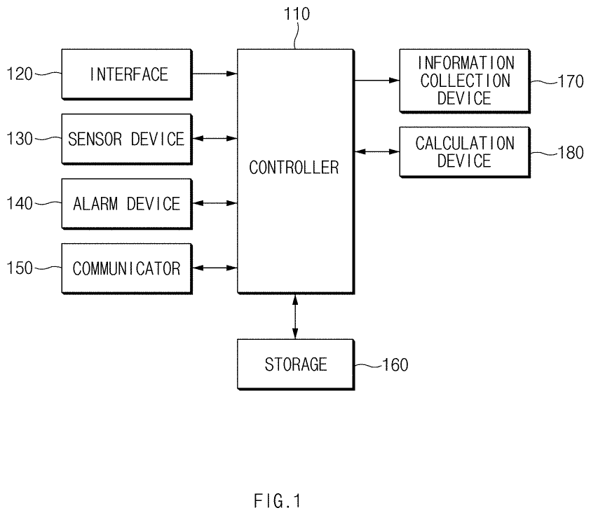

FIG. 1 is a block diagram illustrating a configuration of an autonomous driving control apparatus in some forms of the present disclosure.

The autonomous driving control apparatus 100 may be implemented inside a vehicle. At this time, the autonomous driving control apparatus 100 may be integrally formed with internal control units of the vehicle; the autonomous driving control apparatus 100 may be implemented as a separate apparatus to be connected to the control units of the vehicle by a separate connection means. Herein, the autonomous driving control apparatus 100 may operate in conjunction with the engine and the motor of the vehicle and may operate in conjunction with a control unit that controls the operation of the engine and the motor. For example, the autonomous driving control apparatus 100 may be implemented as an autonomous driving control system.

Referring to FIG. 1, the autonomous driving control apparatus 100 may include a controller 110, an interface 120, a sensor device 130, an alarm device 140, a communicator 150, storage 160, an information collection device 170, and an calculation device 180.

Herein, the controller 110, the information collection device 170, and the calculation device 180 of the autonomous driving control apparatus 100 in some forms of the present disclosure may be implemented with at least one or more processors. At this time, the controller 110 may process a signal transmitted between the respective components of the autonomous driving control apparatus 100.

The interface 120 may include an input means for receiving a control command from a user and an output means for outputting the operation state, operation result, and the like of the autonomous driving control apparatus 100.

Herein, the input means may include a key button and may include a mouse, a joystick, a jog shuttle, a stylus pen, and the like. Furthermore, the input means may also include a soft key implemented on the display.

The output means may include a display and may include a voice output means such as a speaker. At this time, when a touch sensor such as a touch film, a touch sheet, or a touch pad is included in the display, the display may operate as a touch screen and may be implemented in the form in which the input means and the output means are integrated with each other.

At this time, the display may include at least one of a liquid crystal display (LCD), a thin film transistor-liquid crystal display (TFT-LCD), an organic light-emitting diode (OLED), a flexible display, a field emission display, or a 3D display.

The sensor device 130 may include a plurality of sensors that sense driving information about the driving vehicle.

For example, the sensor device 130 may include a sensor that senses control information of the vehicle. Herein, the control information of the vehicle may include braking information, acceleration information, wheel slip information, and/or travel distance information. Moreover, the sensor device 130 may sense information about the error or failure of the plurality of sensors.

Furthermore, the sensor device 130 may include a sensor that senses external environment information. For example, the sensor that senses external environment information may be a camera sensor. The camera sensor may capture an external front view image, a road image, a moving object image, or the like and may sense moving object information (e.g., a pedestrian, an obstacle, a nearby vehicle, or the like), lane information, road information, and/or road surface state information from the captured image. Also, the sensor device 130 may further include a sensor that senses information of a driving route.

In addition to the above-described sensors, as long as a sensor collects information associated with the vehicle, which is driving, and/or the driving of the vehicle, the sensor may be applied to the sensor device 130.

The alarm device 140 is a means that outputs an alarm or warning depending on the control signal from the controller 110. The alarm device 140 may include at least one or more alarm means that allows a driver to recognize a specific event situation. For example, the alarm means may include a means that outputs an alarm sound such as a buzzer, or the like. Moreover, the alarm means may include a vibration output means included in a steering wheel and/or a seat. Furthermore, the alarm means may include a light output means such as an interior lighting, a warning lighting on a dashboard, or the like.

The alarm means may correspond to a means as long as the means allows the driver to recognize an event situation.

The communicator 150 may include a communication module that supports a communication interface with sensors, automotive components, and/or control units included in the vehicle. The communication module may receive at least a piece or pieces of driving information from each of the control units of the vehicle. For example, the communication module may receive road information, congested section information, curve section information, node information such as intersection, crosswalk, and/or speeding bump, or the like, which is within a specific distance in front on a driving route from a navigation device.

Herein, the communication module may include a module that supports vehicle network communication such as Controller Area Network (CAN) communication, Local Interconnect Network (LIN) communication, Flex-Ray communication, or the like.

Furthermore, the communicator 150 may further include a communication module for wireless Internet access or short range communication. For example, the communication module may receive weather information.

Herein, the wireless Internet technology may include wireless LAN (WLAN), Wireless Broadband (Wibro), Wi-Fi, a World Interoperability for Microwave Access (Wimax), and the like; the short range communication technology may include Bluetooth, ZigBee, Ultra Wideband (UWB), Radio Frequency Identification (RFID), Infrared Data Association (IrDA), and the like.

The storage 160 may store data and/or an algorithm required to operate the autonomous driving control apparatus 100. For example, the storage 160 may store setting value, condition information, commands, and/or algorithms set such that the autonomous driving control apparatus 100 performs the autonomous driving of the vehicle. In addition, the storage 160 may store a command and/or an algorithm that computes the reliability of the preset items, computes integrated reliability from the computed reliability, and guides the integrated reliability to the driver, while the autonomous driving control apparatus 100 performs the autonomous driving.

Herein, the storage 160 may include a storage medium such as a Random Access Memory (RAM), a Static Random Access Memory (SRAM), a Read-Only Memory (ROM), a Programmable Read-Only Memory (PROM), or an Electrically Erasable Programmable Read-Only Memory (EEPROM).

The controller 110 may control the autonomous driving of the vehicle, under the preset condition.

The information collection device 170 collects driving information of the vehicle while the vehicle is during autonomously by the controller 110. For example, the information collection device 170 may collect at least a piece or pieces of operating state information about the vehicle. Moreover, the information collection device 170 may collect at least a piece or pieces of external environment information. Furthermore, the information collection device 170 may collect information about a road on a driving route. Also, the information collection device 170 may collect state information of a sensor and/or a collecting device that collects the pieces of information.

Herein, while the vehicle is driving autonomously, the information collection device 170 may collect driving information in real time or may collect driving information periodically.

The information collection device 170 may store the collected driving information in the storage 160. Moreover, the information collection device 170 may also transmit the collected driving information to the controller 110 and/or the calculation device 180.

The calculation device 180 computes the integrated reliability of the autonomous driving control of the vehicle, using the driving information collected by the information collection device 170.

At this time, the calculation device 180 computes reliability of each of a predefined plurality of items and computes the integrated reliability of the autonomous driving control of the vehicle based on the computed reliability of each of the items.

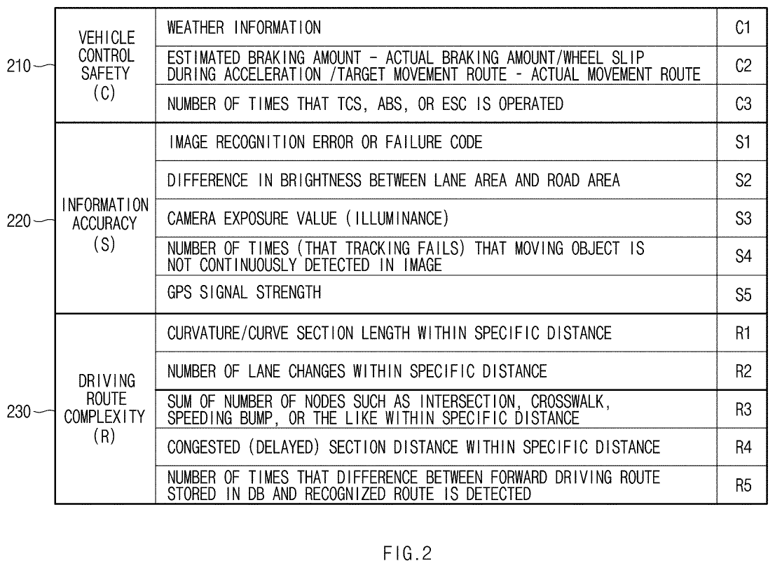

Herein, the plurality of items for computing the reliability may be defined as illustrated in FIG. 2. Referring to FIG. 2, the plurality of items may be roughly separated into items 210 for computing reliability (hereinafter, referred to as “first reliability”) based on the safety of vehicle control, items 220 for computing reliability (hereinafter, referred to as “second reliability”) based on the accuracy of external environment information, and items 230 for computing reliability (hereinafter, referred to as “third reliability”) based on the complexity of a driving route.

First, the items 210 for computing the first reliability may correspond to weather information, the difference between an estimated braking amount and an actual braking amount, wheel slip during acceleration, the difference between a target route and an actual movement route, or the number of times that TCS, ABS, ESC, or the like is operated, as factors that affect the safety during driving. Because the above-described items 210 are factors that degrade the first reliability, the deduction rate of each item may be computed and then the computed deduction rate may be deducted from the first reliability.

First, the calculation device 180 may compute a deduction rate C1 according to the weather information.

It is difficult to control the attitude upon controlling acceleration, braking, turning, or the like when the road surface is wet or frozen due to snow, rain, or the like. Accordingly, the calculation device 180 may compute first reliability to be low, based on the weather information collected in advance by the information collection device 170. Herein, the weather information may be obtained through a road surface image or may be received from the server of the meteorological administration connected to Internet.

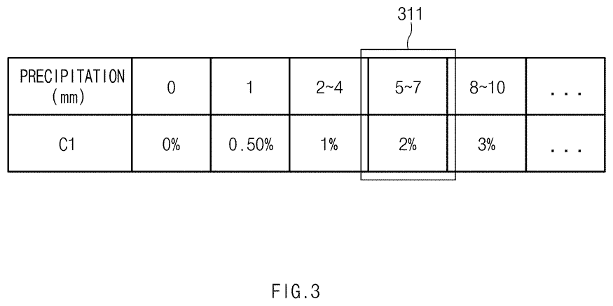

The deduction rate C1 according to the weather information may be computed using the conversion map defined in advance depending on a weather state. In some forms of the present disclosure, the conversion map defined in advance depending on a weather state will be described with reference to FIG. 3.

FIG. 3 illustrates the conversion map of the deduction rate C1 according to precipitation. For example, the deduction rate C1 corresponding to the precipitation of 5 mm corresponds to 2% as illustrated in a reference number 311, assuming that the precipitation corresponds to 5 mm per hour. Accordingly, the calculation device 180 may determine the deduction rate C1 according to the precipitation from the conversion map of FIG. 3.

Also, the calculation device 180 may compute a deduction rate C2, using at least one of the difference between the estimated braking amount and the actual braking amount, wheel slip during acceleration, the difference between a target route and an actual movement route.

The calculation device 180 may compute the first reliability to be low, when the amount of wheel slip, which is unexpected while the vehicle is autonomously driving, increases, when the actual braking amount increase as compared to the estimated braking amount, or when the difference between the target driving route and the actual movement route increases. Herein, the difference between the estimated braking amount and the actual braking amount and the amount of wheel slip during acceleration may be detected by a braking controller through the difference in wheel speed, the vehicle speed change compared to braking torque, or the like. Moreover, the difference between the target route and the actual movement route may be tracked from a target movement route, GPS, an acceleration sensor, or the like by an autonomous driving controller.

At this time, the calculation device 180 may compute a deduction rate C2 by multiplying the difference value of each item by the conversion factor. For example, the calculation device 180 may compute the deduction rate C2 according to the braking amount from Equation 1 below.

C2=(actual braking amount−estimated braking amount)×conversion factor [Equation 1]

Herein, the deduction rate C2 according to the braking amount may be 1%, when it is assumed that the estimated braking amount is 10 bar, the actual braking amount is 11 bar, and the conversion factor is ‘1’. Accordingly, the calculation device 180 may determine the deduction rate C2 according to the braking amount from Equation 1.

Furthermore, the calculation device 180 may calculate a deduction rate C3 according to attitude correction, based on the number of times that the attitude control system such as TCS, ABS, and ESC is operated during a specific time.

Herein, TCS denotes a system that controls the driving force of a vehicle by preventing slipping or idling, as the abbreviation of Traction Control System. ABS denotes a system that prevents wheel locking when suddenly braking and allows four wheels to be balanced, as the abbreviation of Anti-lock Brake System. Like TCS, ESC denotes a system that prevents the vehicle from slipping on wet roads, icy roads, steep curve roads, or the like and prevents accidents by maintaining safety, as the abbreviation of Electronic Stability Control.

Because the number of operations in the systems, such as TCS, ABS, and ESC, increases as the safety of the vehicle is degraded, the calculation device 180 may compute the first reliability to be low as the number of times that TCS, ABS and ESC is operated increases.

At this time, the calculation device 180 may compute the deduction rate C3 according to attitude correction by multiplying the number of times that TCS, ABS and ESC is operated, by the conversion factor. For example, the calculation device 180 may compute the deduction rate C3 according to the attitude correction from Equation 2 below.

C3=the number of times (that TCS, ABS, or ESC is operated)×conversion factor [Equation 2]

Herein, the deduction rate C3 according to the attitude correction may be 2%, assuming that the number of times that TCS, ABS, or ESC is operated during 10 minutes is four times and the conversion factor is ‘0.5’. Accordingly, the calculation device 180 may determine the deduction rate C3 according to the attitude correction from Equation 2.

Each of the conversion factors of Equation 1 and Equation 2 may be assigned differently depending on the importance, priority, or the like of the corresponding item, and may vary depending on the forms of the present disclosure.

The calculation device 180 may compute the first reliability ‘C’ with reference to Equation 3 below, when all the deduction rates C1, C2, and C3 of the respective items 210 for computing the first reliability are computed.

C=100−(C1+C2+C3) [Equation 3]

For example, because the previously computed C1 is 2%, the previously computed C2 is 1%, and the previously computed C3 is 2%, the first reliability ‘C’ may be 95% (C=100−(2+1+2)=95%), when the calculation device 180 applies C1, C2, and C3 to Equation 3.

In the meantime, the items 220 for computing the second reliability may correspond to the error or failure code of a sensor and/or an actuator, the brightness difference between a lane area and a road area in an image, a camera exposure value (illuminance), the number of times that a moving object such as a nearby vehicle, an obstacle, a pedestrian, or the like is not continuously detected in the image, or the like.

Because the items 220 for determining the accuracy of the above-described external information are factors that degrade the reliability, the deduction rate of each item may be computed and then the computed deduction rate may be deducted from the reliability.

First, the calculation device 180 may compute a deduction rate S1 according to the error (or failure).

Herein, because the error or failure code of a sensor and/or an actuator is a major factor that reduces reliability in autonomous driving control, the deduction rate S1 may be calculated as 0% when the error (or failure) does not occur; otherwise, the deduction rate S1 may be calculated as 100%. The deduction rate S1 according to the error (or failure) may be adjusted depending on the importance of the sensor in which the error (or failure) occurs, when the error (or failure) occurs.

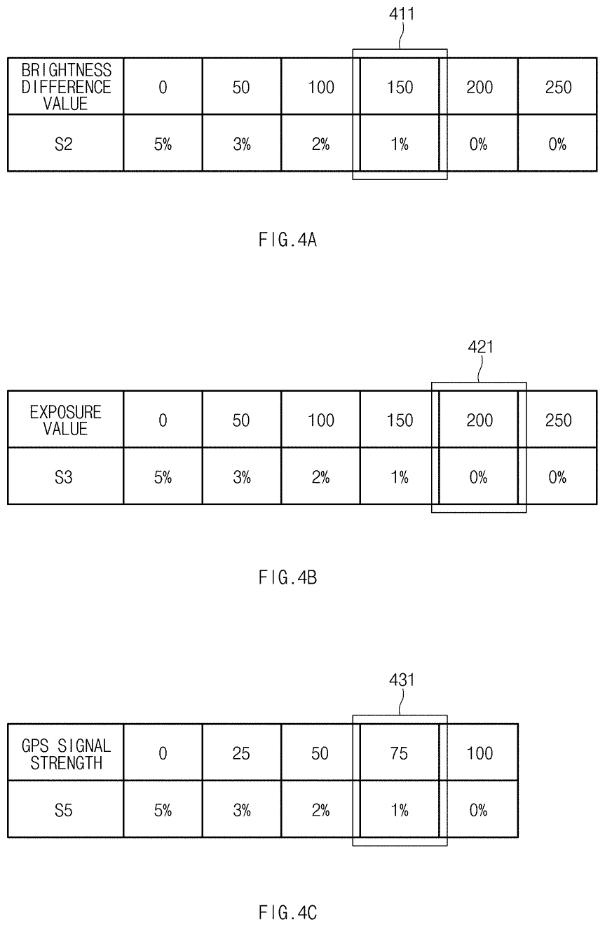

Moreover, the calculation device 180 may compute the deduction rate S2 depending on the difference in brightness between the lane area and the road area in the road image. The deduction rate S2 according to the difference in brightness for each area may be computed using the conversion map defined in advance depending on a brightness difference value. In some forms of the present disclosure, the conversion map defined depending on the brightness difference value will be described with reference to FIG. 4A.

FIG. 4A illustrates the conversion map of the deduction rate S2 according to the brightness difference value. For example, the deduction rate S2 corresponding to the brightness difference value of 150 may correspond to 1% as illustrated in a reference number 411, assuming that the brightness of the lane area in the road image is 200 and the brightness of the road area in the road image is 50. Accordingly, the calculation device 180 may determine the deduction rate S2 according to the brightness difference value from the conversion map of FIG. 4A.

Moreover, the calculation device 180 may compute a deduction rate S3 depending on the exposure value (illuminance) of a camera. The deduction rate S3 according to the camera exposure value may be computed using the conversion map defined in advance depending on the camera exposure value. In some forms of the present disclosure, the conversion map defined depending on the camera exposure value will be described with reference to FIG. 4B.

FIG. 4B illustrates the conversion map of the deduction rate S3 according to the exposure value. For example, the deduction rate S3 corresponding to the exposure value of 200 may correspond to 0% as illustrated in a reference number 421, assuming that the camera exposure value is 200. Accordingly, the calculation device 180 may determine the deduction rate S3 according to the exposure value from the conversion map of FIG. 4B.

Moreover, the calculation device 180 may compute a deduction rate S4 depending on depending on the number of times (the number of times that tracking fails) that a moving object is not continuously detected in an image, when an object (the moving object) such as a nearby vehicle, an obstacle, or a pedestrian is detected from the image. At this time, the calculation device 180 may compute a deduction rate S4 by multiplying the number of times that tracking of the moving object fails by the conversion factor. For example, the calculation device 180 may compute the deduction rate S4 according to the tracking failure from Equation 4 below.

S4=the number of times(that tracking fails)×conversion factor [Equation 4]

Herein, the deduction rate S4 according to the tracking failure may be 2%, assuming that the number of times that tracking of a nearby vehicle, an obstacle, a pedestrian, or the like fails for 10 minutes is ‘2’ and the conversion factor is ‘1’. Accordingly, the calculation device 180 may determine the deduction rate S4 according to the tracking failure from Equation 4. The conversion factors of Equation 4 may be assigned depending on the importance, priority, or the like of the corresponding item, and may vary depending on the forms of the present disclosure.

Moreover, the calculation device 180 may compute a deduction rate S5 depending on GPS signal strength. The deduction rate S5 according to the GPS signal strength may be computed using the conversion map defined in advance depending on the GPS signal strength. In some forms of the present disclosure, the conversion map defined depending on the GPS signal strength will be described with reference to FIG. 4C.

FIG. 4C illustrates the conversion map of the deduction rate S5 according to the GPS signal strength. For example, the deduction rate S5 corresponding to the GPS signal strength of 75 may correspond to 1% as illustrated in a reference number 431, assuming that the GPS signal strength is 75. Accordingly, the calculation device 180 may determine the deduction rate S5 according to the GPS signal strength from the conversion map of FIG. 4C.

The calculation device 180 may compute the second reliability ‘C’ with reference to Equation 5 below, when all the deduction rates S1, S2, S3, S4, and S5 of the respective items 220 for computing the second reliability are computed.

S=100−(S1+S2+S3+S4+S5) [Equation 5]

For example, because the previously computed S1 is 0%, the previously computed S2 is 1%, the previously computed S3 is 0%, the previously computed S4 is 2%, and the previously computed S5 is 1%, the second reliability ‘S’ may be 96% (S=100−(0+1+0+2+1)=96%), when the calculation device 180 applies S1, S2, S3, S4, and S5 to Equation 5.

In the meantime, the items 230 for computing the third reliability may correspond to the curvature and length of a curve section, the number of lane changes, the number of nodes such as an intersection, a crosswalk, a speeding bump, or the like, the number of congested (delayed) sections, the difference between a forward driving route stored in a DB and the recognized route, or the like, which is within a specific distance from the current location on a driving route. Because the above-described items 230 are factors that degrade the third reliability, the deduction rate of each item may be computed and then the computed deduction rate may be deducted from the third reliability.

First, the calculation device 180 may compute the deduction rate R1 according to the curvature and length of a curve section. At this time, the calculation device 180 may compute the deduction rate R1 by multiplying the distance of the curve section, of which the curvature radius is within a specific value, by the conversion factor. For example, the calculation device 180 may compute the deduction rate R1 according to the distance of the curve section from Equation 6 below.

R1=curve section length×conversion factor [Equation 6]

Herein, the deduction rate R1 according to the distance of the curve section may be 1%, assuming that the length of the curve section, of which the curvature radius is not greater than 10 m, is 100 m and the conversion factor is 0.01. Accordingly, the calculation device 180 may determine the deduction rate R1 according to the length of the curve section from Equation 6.

Moreover, the calculation device 180 may compute the deduction rate R2 according to the number of lane changes. At this time, the calculation device 180 may compute the deduction rate R2 by multiplying the number of lane changes within a specific distance from the current location, by the conversion factor. For example, the calculation device 180 may compute the deduction rate R2 according to the number of lane changes from Equation 7 below.

R2=the number of lane changes×conversion factor [Equation 7]

Herein, the deduction rate R2 according to the number of lane changes may be 2%, assuming that the number of times that lane change is required within a forward specific distance from the current location is four times and the conversion factor is ‘0.5’. Accordingly, the calculation device 180 may determine the deduction rate R2 according to the number of lane changes from Equation 7.

Moreover, the calculation device 180 may compute the deduction rate R3 according to the number of forward nodes. At this time, the calculation device 180 may compute the deduction rate R3 by multiplying the number of nodes such as an intersection, a crosswalk, a speeding bump, or the like, which is located within a forward specific distance from the current location, by the conversion factor. For example, the calculation device 180 may compute the deduction rate R3 according to the number of nodes from Equation 8 below.

R3=the number of nodes×conversion factor [Equation 8]

Herein, the deduction rate R3 according to the number of nodes may be 2%, assuming that the number of nodes such as an intersection, a crosswalk, a speeding bump, or the like, which is located within a forward specific distance from the current location is four and the conversion factor is ‘0.5’. Accordingly, the calculation device 180 may determine the deduction rate R3 according to the number of nodes from Equation 8.

Moreover, the calculation device 180 may compute the deduction rate R4 according to the number of congested (delayed) sections. At this time, the calculation device 180 may compute the deduction rate R4 by multiplying the number of congested (delayed) sections within a forward specific distance from the current location, by the conversion factor. For example, the calculation device 180 may compute the deduction rate R4 according to the number of congested (delayed) sections from Equation 9 below.

R4=the number of congested(delayed)sections×conversion factor [Equation 9]

Herein, the deduction rate R4 according to the number of congested (delayed) sections may be 1%, assuming that the number of congested (delayed) sections within a forward specific distance from the current location is one and the conversion factor is ‘1’. Accordingly, the calculation device 180 may determine the deduction rate R4 according to the number of congested (delayed) sections from Equation 9.

Moreover, the calculation device 180 may compute the deduction rate R5 according to the route change. At this time, the calculation device 180 may compute the deduction rate R5 by multiplying the number of times that the change of a driving route is detected by the difference between a forward driving route stored in a DB and the recognized route, by the conversion factor. For example, the calculation device 180 may compute the deduction rate R5 according to the route change from Equation 10 below.

R5=the number of times that route change is detected×conversion factor [Equation 10]

Herein, the deduction rate R5 according to the route change may be 2%, assuming that the number of times that the change of a driving route is detected is one and the conversion factor is ‘2’. Accordingly, the calculation device 180 may determine the deduction rate R5 according to the route change from Equation 10.

Each of the conversion factors of Equation 6 to Equation 10 may be assigned differently depending on the importance, priority, or the like of the corresponding item, and may vary depending on the forms of the present disclosure.

As described above, the calculation device 180 may compute the third reliability ‘R’ with reference to Equation 11 below, when all the deduction rates R1, R2, R3, R4, and R5 of the respective items 230 for computing the third reliability are computed.

R=100−(R1+R2+R3+R4+R5) [Equation 11]

For example, because the previously computed R1 is 1%, the previously computed R2 is 2%, the previously computed R3 is 2%, the previously computed R4 is 1%, and the previously computed R5 is 2%, the third reliability ‘R’ may be 92% (R=100−(1+2+2+1+2)=92%), when the calculation device 180 applies R1, R2, R3, R4, and R5 to Equation 11.

The calculation device 180 may compute integrated reliability according to autonomous driving control, based on the first reliability ‘C’, the second reliability ‘S’, and the third reliability ‘R’ computed through Equation 3, Equation 5, and Equation 11. At this time, the calculation device 180 may apply the first reliability ‘C’, the second reliability ‘S’, and the third reliability ‘R’ to Equation 12 below to compute the integrated reliability according to the autonomous driving control.

$$Integrated reliability = \{ \frac{C}{100} \times \frac{S}{100} \times \frac{R}{100} \} \times 100 \qquad [ Equation 12 ]$$

For example, because the previously computed first reliability ‘C’ is 95%, the previously computed second reliability ‘S’ is 96%, and the previously computed third reliability ‘R’ is 92%, the integrated reliability may be 84% ({(95/100×96/100×92/100)}×100≈84%), when the first reliability ‘C’, the second reliability ‘S’, and the third reliability ‘R’ are applied to Equation 12.

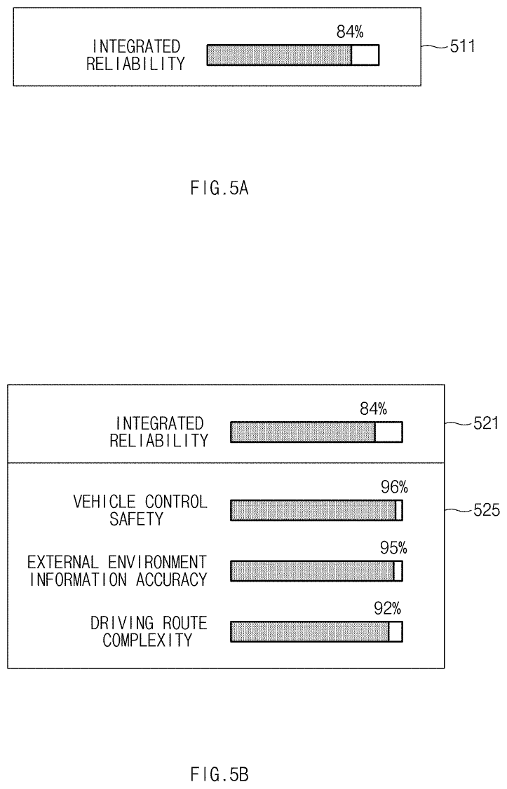

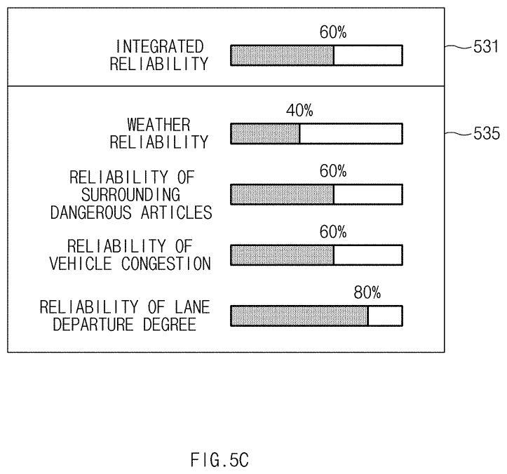

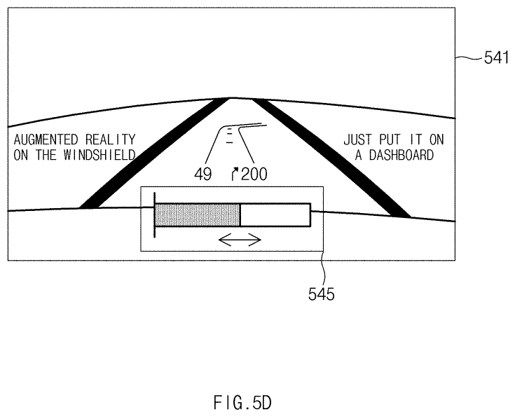

The controller 110 may allow integrated reliability information according to the autonomous driving control to be displayed through a display, when the computation of the integrated reliability is completed by the calculation device 180. This will be described with reference to FIG. 5A. As illustrated in FIG. 5A, the integrated reliability information may be implemented in the form of a bar graph as illustrated in a reference number 511. It is reasonable that this can be implemented with images and/or emoticons of various forms capable of representing the rate of the integrated reliability.

Furthermore, as illustrated in FIG. 5B, the controller 110 may display first to third reliability information 525 for each item through the display, in addition to integrated reliability information 521.

In the meantime, as illustrated in FIG. 5C, the controller 110 may display reliability information 535 about the respective item selected by a user, through the display in addition to integrated reliability information 531. In this case, the controller 110 make a request for reliability computation of the respective item selected by the user, to the calculation device 180.

Only the reliability information may be displayed on a display screen. In the meantime, as illustrated in FIG. 5D, the reliability information may be displayed in one area a navigation screen 541 in the form overlapping with reliability information 545.

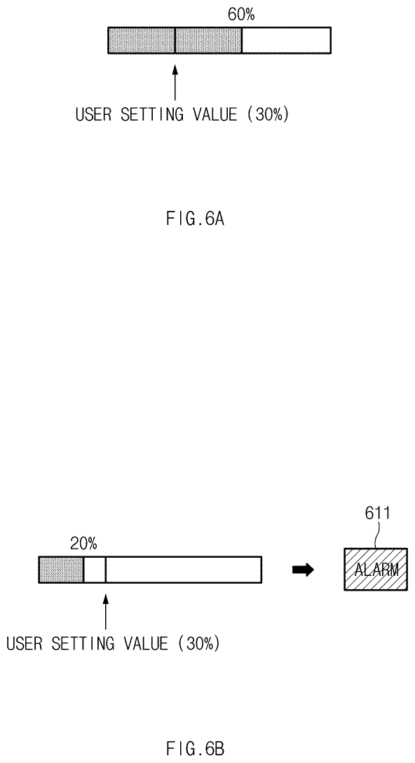

The controller 110 may compare the integrated reliability according to the autonomous driving control with the preset user setting value. As illustrated in FIG. 6A, the controller 110 may display and guide the reliability information on a display, when it is determined that the integrated reliability is not less than the user setting value.

Meanwhile, as illustrated in FIG. 6B, the controller 110 may allow an alarm 611 to be output by transmitting an alarm control signal to the alarm device 140, when it is determined that the integrated reliability is less than the user setting value. In this case, the controller 110 may display a reliability warning message through the display, together.

As such, the alarm device 140 may allow a driver to recognize the warning state of reliability according to autonomous driving, by outputting an alarm through vibration means of a steering wheel and/or a vibration means in a seat depending on the alarm control signal of the controller 110.

Moreover, the controller 110 may transmit the alarm control signal to a user terminal connected by the communicator 150 in the wireless communication scheme, when it is determined that the integrated reliability is less than the user setting value.

The controller 110 may display a message for inducing the adjustment of the driving setting value through a display or may output a guide voice through a speaker, when a driving setting value is not adjusted by a driver after the warning state of the reliability is guided through a warning message and an alarm.

In the meantime, the controller 110 may automatically adjust the driving setting value and may control the autonomous driving according to the adjusted driving setting value, when a state where the reliability according to the autonomous driving control is less than the preset setting value is maintained for a specified time or more. For example, the controller 110 may adjust the preset target control vehicle speed to be less than or equal to a specific speed. Furthermore, the controller 110 may adjust the level at which a driver feels comfortable, to be less than or equal to a specific level.

In this case, as a vehicle is autonomously driving depending on the automatically adjusted driving setting value, the integrated reliability according to autonomous driving control may be restored to the user setting value or more.

The controller 110 may search for a safety zone located at the closest distance to control the vehicle to stop in the safety zone, when the integrated reliability is not restored to the user setting value or more or the driving setting value is not adjusted by the driver any more after the controller 110 performs the autonomous driving control depending on the automatically adjusted driving setting value.

The autonomous driving control apparatus 100 in some forms of the present disclosure operating as described above may be implemented in the form of an independent hardware device including a memory and a processor for processing each operation and may be driven in the form included in other hardware devices such as a microprocessor or a general purpose computer system.

The operation flow of the autonomous driving control apparatus in some forms of the present disclosure will be described in more detail as follows.

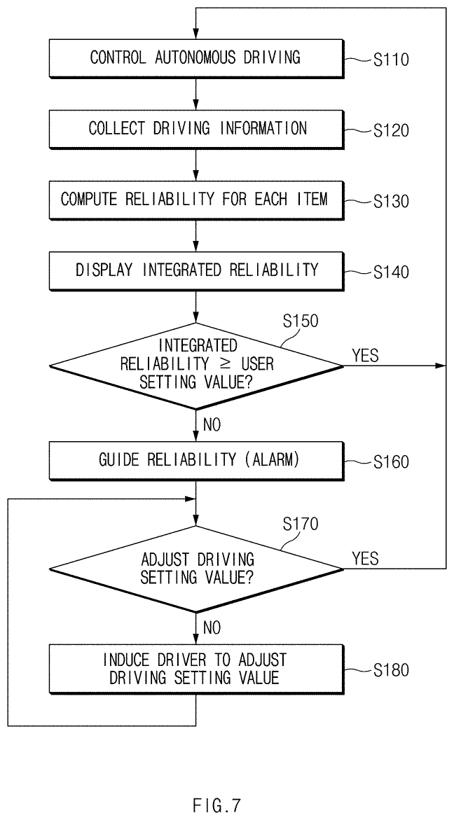

FIG. 7 is a diagram illustrating an operation flow of a reliability information guidance method of an autonomous driving control apparatus in some forms of the present disclosure.

Referring to FIG. 7, in S110, the autonomous driving control apparatus 100 may control the autonomous driving of a vehicle depending on a preset driving setting value.

In S120, the autonomous driving control apparatus 100 may collect driving information of the vehicle, while controlling the autonomous driving of the vehicle. In S120, the autonomous driving control apparatus 100 may collect the driving information corresponding to the each preset item. The driving information for each item refers to FIG. 2.

In S130, the autonomous driving control apparatus 100 computes the reliability for each item, using the driving information collected in S120. In S140, the autonomous driving control apparatus 100 computes the integrated reliability according to autonomous driving control, from the reliability for each item computed in S130 to display the integrated reliability on a display.

At this time, the autonomous driving control apparatus 100 may repeatedly perform S110 to S140, when the integrated reliability information in S140 is not less than a preset user setting value, for example, 30% in S150.

In the meantime, in S160, the autonomous driving control apparatus 100 guides the reliability state by determining that a current state is a reliability warning state and outputting an alarm to the driver, when the integrated reliability information in S140 is less than the preset user setting value, for example, 30% in S150.

The autonomous driving control apparatus 100 may repeatedly perform S110 to S140 based on the adjusted setting value, when the driver that identifies the reliability state guidance in S160 adjusts the driving setting value in S170.

Meanwhile, in S180, the autonomous driving control apparatus 100 may induce the driver to adjust the driving setting value through a message, a guide voice, or the like, when the driving setting value is not adjusted after S160. Afterward, the autonomous driving control apparatus 100 may repeatedly perform S110 to S140 based on the adjusted setting value, when the driver adjusts the driving setting value in S170.

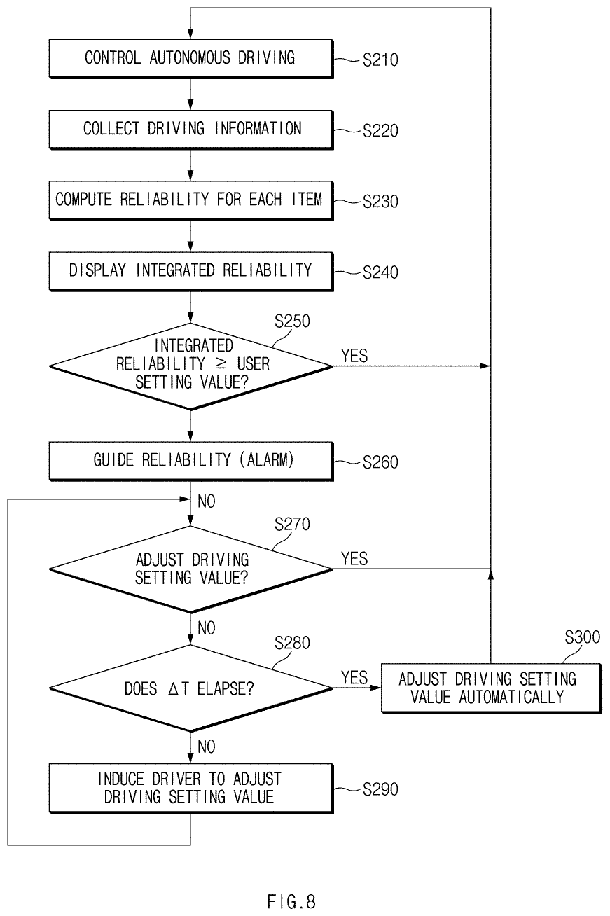

FIG. 8 is a diagram illustrating an operation flow of a reliability information guidance method of an autonomous driving control apparatus, in some forms of the present disclosure. S210 to S270 of FIG. 8 are the same as S110 to S170 of FIG. 7. As such, the duplicate description of the same process may be omitted.

In S280, the autonomous driving control apparatus 100 may induce the driver to adjust the driving setting value through a message, a guide voice, or the like, when the driving setting value is not adjusted in S270 after the reliability state is guided in S260.

In the meantime, in S300, the autonomous driving control apparatus 100 may automatically adjust the driving setting value, in S280, when a specified time elapses after the reliability according to autonomous driving control is less than the preset setting value. Accordingly, the autonomous driving control apparatus 100 may repeatedly perform S210 to S240 based on the adjusted setting value.

In this case, the integrated reliability according to autonomous driving control may be restored to the user setting value or more, by repeatedly performing S210 to S240 based on the adjusted setting value.

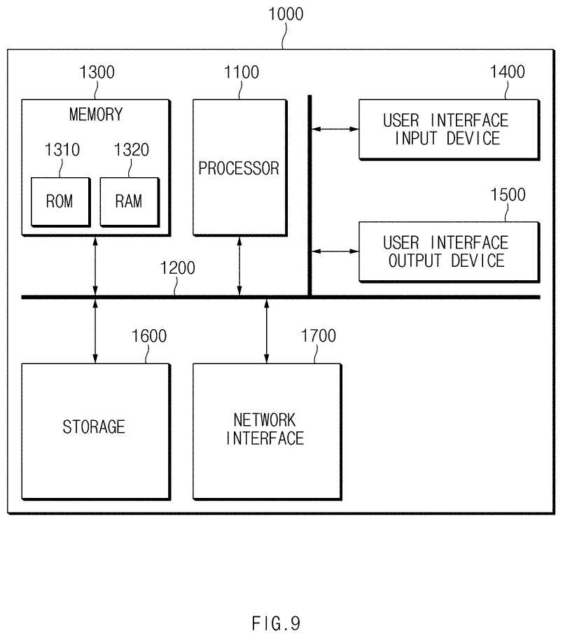

FIG. 9 is a block diagram illustrating a computer system performing a method in some forms of the present disclosure. Referring to FIG. 9 a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in some forms of the present disclosure disclosed herein may be embodied directly in hardware or a software module executed by the processor 1100, or in a combination thereof. The software module may reside on a storage medium (that is, the memory 1300 and/or the storage 1600) such as a RAM memory, a flash memory, a ROM memory, an EPROM memory, an EEPROM memory, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

Hereinabove, although some forms of the present disclosure has been described and the accompanying drawings, the present disclosure is not limited thereto, but may be variously modified and altered by those skilled in the art to which the present disclosure pertains without departing from the spirit and scope of the present disclosure claimed in the following claims.

In some forms of the present disclosure, a driver may feel secure during autonomous driving by computing the reliability of each of a plurality of items to notify the driver of reliability information while the autonomous driving of a vehicle is performed; the safety may be improved by allowing a user to recognize a reliability warning state through an alarm when reliability information computed during the autonomous driving is less than a user setting value.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An autonomous driving control apparatus, the apparatus comprising:
an information collection device configured to collect driving information of an autonomous driving vehicle;
a calculation device configured to compute a reliability of an autonomous driving control based on the collected driving information; and
a controller configured to:
control a driving of the autonomous driving vehicle; and
display information regarding the reliability of the autonomous driving control on a display.

2. The apparatus of claim 1, wherein the driving information comprises at least one of:
first information regarding an operating state of the autonomous driving vehicle;
second information regarding an external environment of the autonomous driving vehicle;
third information regarding a road on a driving route of the autonomous driving vehicle; or
fourth information regarding a sensor configured to sense the first information, the second information, and the third information.

3. The apparatus of claim 1, wherein the calculation device is configured to compute:
a first reliability based on a vehicle control safety;
a second reliability based on an accuracy of the second information; and
a third reliability based on a complexity of the driving route.

4. The apparatus of claim 3, wherein the calculation device is configured to:
compute the first reliability based on the first information and the second information.

5. The apparatus of claim 4, wherein the calculation device is configured to:
compute a first deduction rate based on at least one of:
weather information;
an actual braking amount based on an estimated braking amount;
an amount of wheel slip during acceleration;
an actual movement route based on a target movement route; or
a number of times that an attitude control system is operated; and
lower the first reliability based on the computed first deduction rate.

6. The apparatus of claim 3, wherein the calculation device is configured to:
compute the second reliability based on the second information and the fourth information.

7. The apparatus of claim 6, wherein the calculation device is configured to:
compute a second deduction rate based on at least one of:
information regarding an image recognition error or a failure of a camera;
a difference in brightness between a lane area and a road area in an image;
a camera exposure value;
a number of times that an object tracking fails; or
a GPS signal strength; and
lower the second reliability based on the computed second deduction rate.

8. The apparatus of claim 3, wherein the calculation device is configured to:
compute the third reliability based on the first information and the third information.

9. The apparatus of claim 8, wherein the calculation device is configured to:
compute a third deduction rate based on at least one of:
a curvature and a length of a curve section that are within a predetermined distance from a current location on the driving route;
a number of lane changes;
a number of nodes;
a distance of a congested section; or
a number of times that a change of the driving route is detected; and
lower the third reliability based on the computed third deduction rate.

10. The apparatus of claim 3, wherein the calculation device is configured to:
compute a final reliability of the autonomous driving control by combining the first reliability, the second reliability, and the third reliability.

11. The apparatus of claim 1, wherein the controller is configured to:
output an alarm control signal, when the reliability of the autonomous driving control is lower than a predetermined value.

12. The apparatus of claim 11, wherein the apparatus further comprises:
an alarm device configured to output an alarm depending on the alarm control signal.

13. The apparatus of claim 12, wherein the alarm device is configured to:
output the alarm by vibrating a steering wheel or a seat.

14. The apparatus of claim 1, wherein the controller is configured to:
transmit, to a user terminal, the alarm control signal through a wireless communication, when the reliability of the autonomous driving control is lower than the predetermined value.

15. The apparatus of claim 1, wherein the controller is configured to:
output a message for informing a state of the reliability and adjusting a driving setting value when the reliability of the autonomous driving control is lower than the predetermined value.

16. The apparatus of claim 1, wherein the controller is configured to:
automatically adjust the driving setting value, when a state that the reliability of the autonomous driving control is lower than the predetermined value is maintained for a predetermined amount of time.

17. The apparatus of claim 16, wherein the controller is configured to:
search for a safety zone located at a closest distance to the autonomous driving vehicle and control the autonomous driving vehicle to stop in the safety zone when the reliability of the autonomous driving control is not restored to the predetermined value or the driving setting value is not adjusted by a driver after performing the autonomous driving control depending on the automatically adjusted driving setting value.

18. A reliability information guidance method of an autonomous driving control apparatus, the method comprising:
collecting driving information of an autonomous driving vehicle;
computing a reliability of an autonomous driving control based on the collected driving information;
controlling a driving of the autonomous driving vehicle; and
displaying information regarding the reliability of the autonomous driving control on a display.

19. The method of claim 18, wherein computing the reliability comprises:
computing a first reliability regarding a vehicle control safety based on operating state information of the autonomous driving vehicle and external environment information of the autonomous driving vehicle;
computing a second reliability regarding an accuracy of the external environment information, based on the external environment information and state information of a sensor; and
computing a third reliability regarding a complexity of the driving route based on the operating state information and road information on the driving route.

20. The method of claim 19, wherein computing the reliability further comprises:
computing a final reliability of the autonomous driving control by combining the first reliability, the second reliability, and the third reliability.

21. The method of claim 18, wherein the method further comprises:
outputting an alarm when the reliability of the autonomous driving control is lower than a predetermined value.

22. The method of claim 18, wherein the method further comprises:
when the reliability of the autonomous driving control is lower than the predetermined value, transmitting, to a user terminal, an alarm control signal through a wireless communication.

23. The method of claim 18, wherein the method further comprises:
when the reliability of the autonomous driving control is lower than the predetermined value, outputting a message for informing a state of the reliability and adjusting a driving setting value.

24. The method of claim 18, wherein the method further comprises:
when a state that the reliability of the autonomous driving control is lower than the predetermined value is maintained for a predetermined amount of time, automatically adjusting the driving setting value.
